(19) United States
(12) Patent Application Publication
(10) Pub. No.: US 2006/0222181 A1
(43) Pub. Date: Oct. 5, 2006

(54) Method for transporting real-time audio and video data

(76) Inventors: Hsiu Chung Wu, Taipei City (TW); Chih Chiang Chou, Taipei City (TW); Ching Hsiang Lee, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/391,442

(22) Filed: Mar. 29, 2006

(30) Foreign Application Priority Data
Mar. 30, 2005 (TW) 094110111

(51) Int. Cl. H04L 9/00

(52) U.S. Cl. 380/268; 380/46; 380/263

(57) ABSTRACT

A method for transporting real-time audio and video data is provided, wherein a partial encryption method merely encrypts some packets or some segments thereof in the data stream thereby improve the speed of data process and reduce the load of the processor. Especially for audio data, the malicious interceptor cannot hear the audio data clearly although it is merely partially encrypted.

### BACKGROUND OF THE INVENTION

1. Field of the Invention

The present invention generally relates to a method for real-time transportation of audiovisual data over networks.

2. The Related Arts

Conventional techniques for network data transportation, such as wired or wireless real-time transportation of audio or video data, usually employs a mechanism built on top of Internet. This approach not only includes complicated definition of transportation protocol, but is also hard to build and manage. In addition, the data transportation is not nearly as real-time as the household entertainment appliances.

The popular universal-plug-and-play (UPNP) structure is an open structure defined for home networking. The purpose of UPnP is to link and share the intelligent objects, appliances, PC and services in the home network. UPNP allows different types of network device to be linked without complicated setup or installation processes. For example, a printer conforms to the UPnP specification can be connected to Internet through the home network without connecting to a PC first. No complicated network setting problem is involved, either.

In addition, UPnP is built on top of the existing network standard structure. Both specific network and bus individual configuration are built on top of the existing protocols. Therefore, UPnP is suitable for all the network media, such as, 10BaseT Ethernet, or new network technologies. UPnP does not require a concentrated server for management, so it also improves the home network usability.

However, as the amount of data to be transported is increasing, especially in embedded systems, it is imperative to develop a new solution for real-time data transportation that is more efficient and easier to layout and manage.

### SUMMARY OF THE INVENTION

The present invention provides a real-time audio and video data network transportation system, which is applicable to various structures of wired or wireless network and can also be built on top of different levels of communication protocols, such as UDP, IP, and so on. The system of the present invention can reduce the load on the processor, and is beneficial to the embedded systems. The present invention is easier to manage, and therefore, is suitable for home networking and other smaller network systems.

The first embodiment of the present invention provides a method of establishing multiple channels in a single connection for differentiating non-real-time instructions, such as control, set state, read state. Therefore, the real-time audio and video data can be transported without the effect of the packets containing the non-real-time instructions.

The second embodiment of the present invention provides a method of periodical report on data. With periodic report from the receiving end on the data consumption or the consumption of data buffer, the transmitting end can adjust the speed of data transporting or inform the receiving end to adjust the data consumption speed. Therefore, the speed of data transporting and the speed of data consumption can be synchronized.

The third embodiment of the present invention provides a method of delay response. The delay time can be either randomly determined or determined by the system setting in order to reduce the probability of packet collision.

The fourth embodiment of the present invention is to provide a method of last-in-first-connect policy. Any device on the same network can temporarily interrupt the existing connection between the transmitting end and the receiving end, and establishes a new connection with the receiving end. This simplifies the connection rule. This embodiment does not include a security mechanism to avoid the account management complexity. If a security mechanism is required, the security mechanism can be placed in the underneath lower layer communication protocol.

The fifth embodiment of the present invention provides a method of periodic broadcast of discovering response. A receiving end periodically broadcasts discovering response to all the transmitting ends on the network to notify all the transmitting ends of the existence of the receiving end.

The sixth embodiment of the present invention provides a method of partial noise encryption. By encrypting only certain packets or a segment of some packets in the data stream, the load on the processor is reduced and the speed of data processing is increased. This is especially useful for audio data. Although it is merely partially encrypted, the malicious interception of the audio data cannot be heared clearly.

The seventh embodiment of the present invention is to provide a method of simplifying silence packets. When the data stream includes segments of silence, only the packet header is transported to save the bandwidth.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows the first embodiment of the present invention of a method of establishing multiple channels in a single connection;

FIGS. 2A and 2B show the second embodiment of the present invention of a method of periodical report on data;

FIG. 3 shows the third embodiment of the present invention of a delayed response;

FIGS. 4A and 4B show the fourth embodiment of the present invention of a method with last-in-first-connect policy, and the fifth embodiment of the present invention of a method of periodic broadcast of discovering response; and

FIG. 5 shows the sixth embodiment of the present invention of a method of partial noise encryption and the seventh embodiment of the present invention of a method of simplifying silence packets.

### DETAILED DESCRIPTION OF THE PREFERRED EMBODIMENT

The present invention is usually built on top of UDP, but can also be built on top of lower layer network or communication protocols.

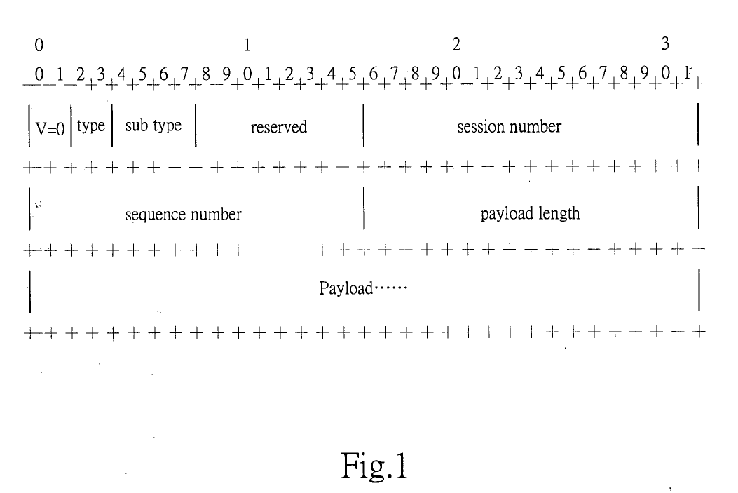

FIG. 1 shows a method of establishing multiple channels of the present invention. As shown in FIG. 1, the first 8 bits of a packet header define the version field, type field and sub-type field, followed by reserved field, session number field, sequence number field, payload length field. The payload follows the packet header. The type field defines the four packet types. For example, “00” indicates a control packet, “01” indicates a management packet, “10” indicates a data packet, and “11” indicates an optional user data type packet. The different types defined in the packet header imply that multiple channels are established in a single connection for differentiating non-real-time instructions for control, set state, and read state. Therefore, the real time audio and video data can be transported without the effect of the transportation of the non-real-time instruction packets.

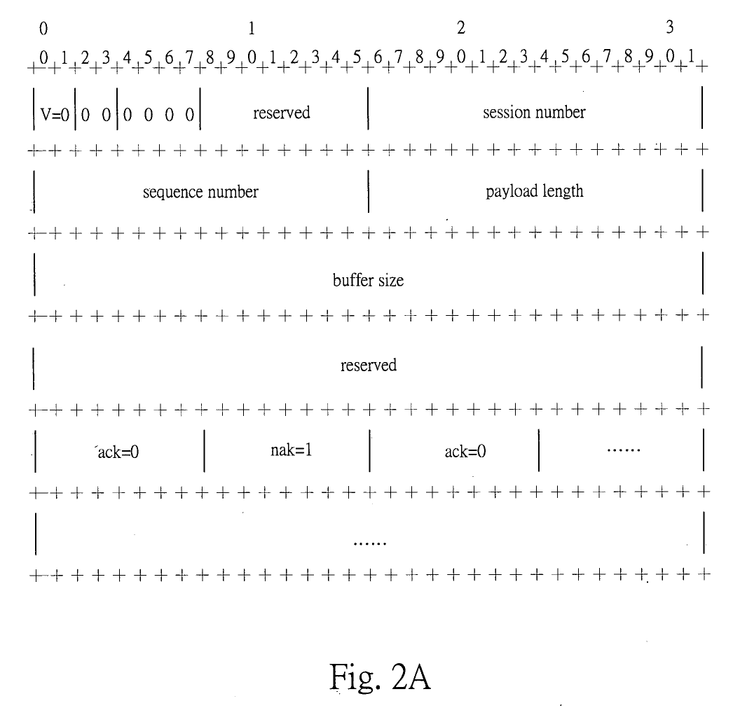

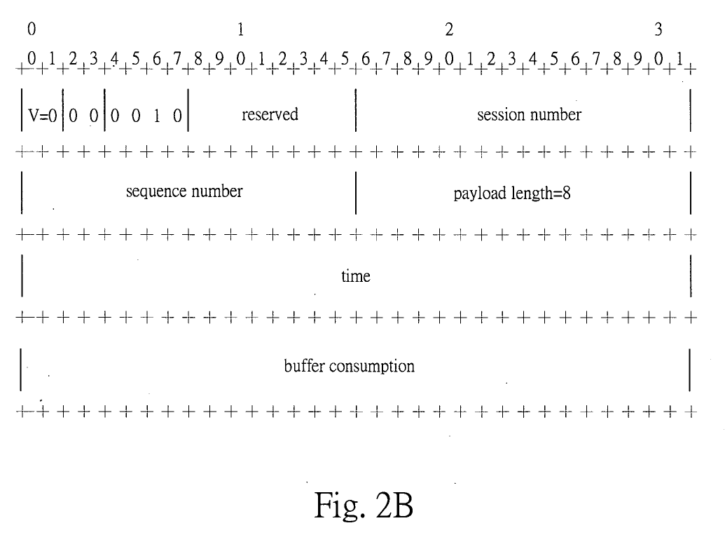

FIGS. 2A and 2B show the second embodiment of the present invention of a method of periodic report on data. When the type field of the header is “00”, the sub-type field is further defined. As shown in FIG. 2A, when the sub-type field is set as “0000” (acknowledge), it indicates the packet is an acknowledgement from the receiving end to the transmitting end and the packet payload contains the information from the receiving end, including the buffer size. As shown in FIG. 2B, when the sub-type field is set as “0010” (buffer consumption report), it indicates the packet is a buffer consumption report packet from the receiving end to the transmitting end and the packet payload contains the information from the receiving end, including the report time from the receiving end and the amount of buffer consumption.

The method also periodically extracts the buffer consumption report packets to compute the consumption rate in order to obtain the latest changes in the consumption.

The data stream consumption rate can be computed using the equation: (Bₙ-B₁)/(Tₙ-T₁), where T and B are the report time of the receiving end and the amount of buffer consumption, respectively. The advantage of this computation is that there is no impact on the result even when one or more report packets are lost between T₁ and Tₙ.

A variation of the buffer consumption report packets is the data stream consumption report packet. The information includes the report time from the receiving end and the amount of data stream consumption.

Through the periodic report from the receiving end on the data stream consumption or the buffer consumption, the transmitting end can adjust the data generation rate or inform the receiving end to adjust its consumption rate so that synchronization between the data generation and data consumption can be achieved.

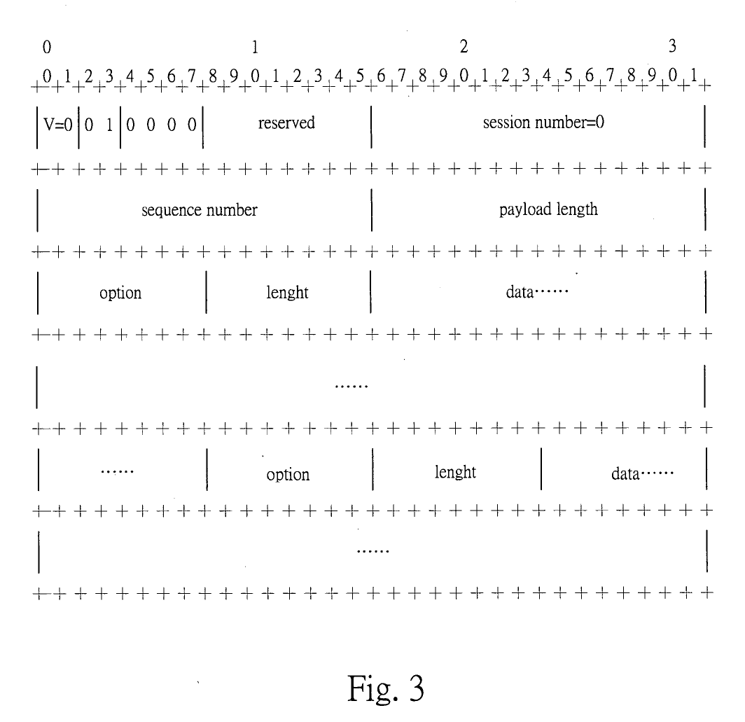

FIG. 3 shows the third embodiment of the present invention of a delay response method. When the type field of the header is “01” (management), the sub-type field is further set. As shown in FIG. 3, when the sub-type is set as “0000”, it indicates a discover request, it indicates a discover packet broadcast by a transmitting end for discovering the existing receiving ends in the network. The header of the packet contains a unique serial number, and the payload contains the options, length, data, and so on. When a receiving end responds to a discover packet, the receiving end sends a packet with the same serial number as the discover packet. However, the sending time of the response packet to the discover packet can be random or pre-determined by the system as to reduce the packet collision probability.

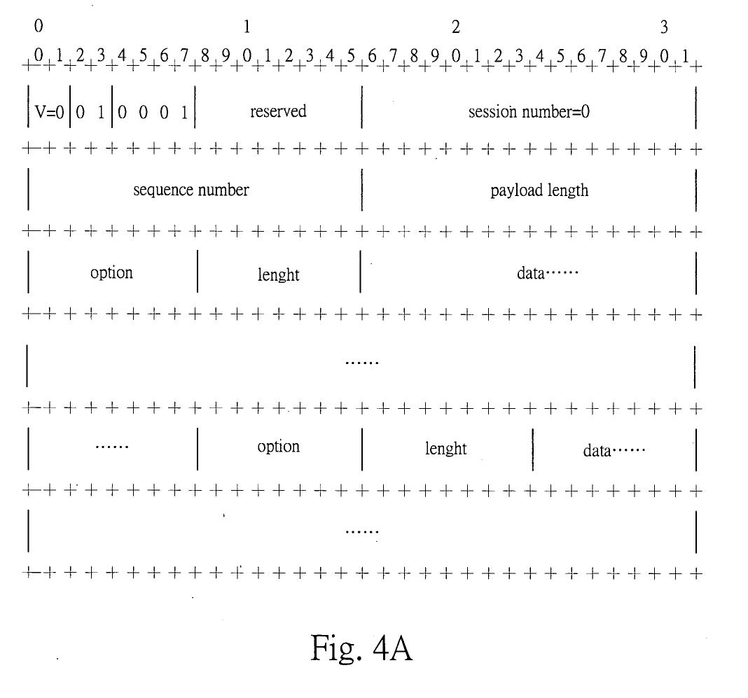

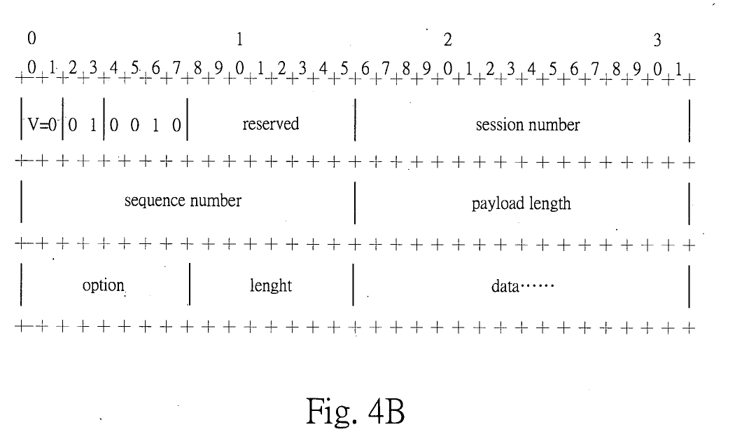

FIGS. 4A and 4B show the fourth embodiment of the present invention of a method with last-in-first-connect policy. When the type field is “01” (management), the sub-type field is further set. As shown in FIG. 4A, when the sub-type is set as “0001”, it indicates an associate request packet from a transmitting end. The session number of the associate packet can be zero for establishing a connection. The receiving ends can send an associate response packet (sub-type field “0015”), with one of them having the only non-zero session number, to the transmitting end. After the connection is established between the transmitting end and the receiving end, the transmitting end can establish another connection with the receiving end without disconnecting the existing connections.

As shown in FIG. 4B, when the sub-type field is set as “0010”, it indicates a disassociate request packet from either the transmitting end or the receiving end to disconnect an existing connection. When a second receiving end intends to disconnect the existing connection, the second receiving end must receive the discover packet from the transmitting end first, and then sends the disassociate packet to request the disconnection of the existing connection. The advantage of this method is that any device on the network can temporarily interrupt the any connection between a transmitting end and a receiving end, and establish the connection with a higher priority. This simplifies the connection rule. This embodiment does not include a security mechanism to avoid the account management complexity. If a security mechanism is required, the security mechanism can be placed in the underneath lower layer communication protocol.

Following the fourth embodiment, the fifth embodiment of the present invention is a method periodic broadcast of discovering response. A receiving end periodically broadcasts discovering response to all the transmitting ends on the network to notify all the transmitting ends of the existence of the receiving end.

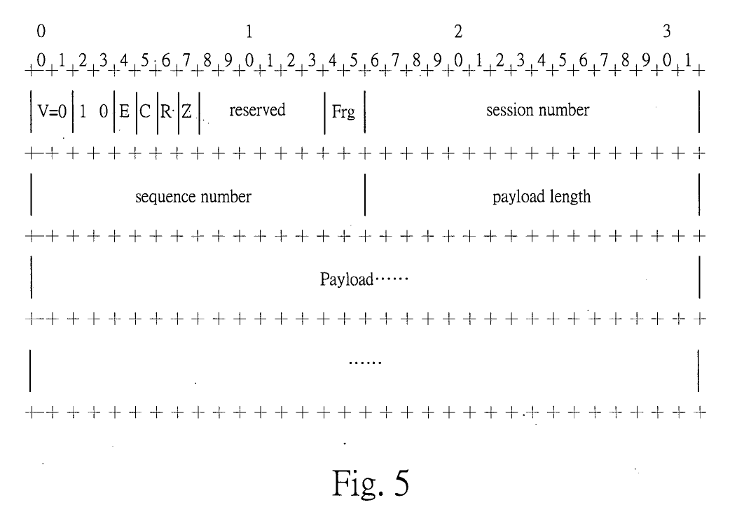

FIG. 5 shows the sixth embodiment of the present invention of a method of partial noise encryption. When the header of the packet is “10”, it indicates a data packet, and the sub-type field is set, including the encryption (E), compression (C), resend (R) and all-zero (Z) fields. When the E field is set as “1”, it indicates the packet is encrypted. The encryption can be performed on only a small segment of a packet or only some of the packets to reduce the load of the processor and increase the processing speed. This is especially useful for audio data. Although only partially encrypting the data, the malicious interception of the audio data will render it hard to hear clearly. The transmitting end can selectively encrypt the packets randomly or even periodically, for example, encryption once for every 10 packets.

The first two values in the payload field of the packet indicate the starting point of the encryption and the length of the encrypted data. If the starting point is “0”, the entire data payload is encrypted.

When the C field is set as “1”, it indicates the packet is compressed. When both encryption and compression are performed, it is preferred to perform the compression before the encryption. As only the partial encryption is used in the method, such execution order assures the overall encryption.

When the R field is set as “1”, it indicates the packet is a re-send of a data packet.

As shown in FIG. 5, the seventh embodiment of the present invention is a simplification of sending silence packet. When the Z field is set as “1”, it indicates the packet is a silent packet. The payload of the silent packet can be eliminated, and only the payload length of the header is kept. When the silence packet is sent, only the header is transported to save the bandwidth.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A method of partial noise encryption for real-time network transportation of audio and video data, comprising the following steps of:
setting an encryption field of a header of at least one packets in a data stream; and
encrypting the packets with the encryption field set.

2. The method as claimed in claim 1, wherein the encrypting step encrypts the entire data in the packets.

3. The method as claimed in claim 1, wherein the encrypting step encrypts only part of the data in the packets.

4. A method of simplifying silence packets for real-time network transportation of audio and video data, comprising the following steps of:
setting an all-zero field of a header of at least one packet in a data stream;
eliminating the all-zero payload of the packets; and
setting a payload length field of the headers of the packets for indicating the eliminated silence payload.

5. A method of establishing multiple channels in a single connection for real-time network transportation of audio and video data, comprising the following steps of:
setting a type field of a header of at least one packets in a data stream for indicating packets for control, set state and read state; and
differentiating packets based on the type field during transporting the packets.

6. The method as claimed in claim 5, wherein different priority is given to different the channels.

7. A method of periodical report on data for real-time network transportation of audio and video data, comprising the following steps of:
setting a buffer consumption report field of a header of at least one packets in a data stream to for indicating the packets being report packets from a receiving end to a transmitting end, payload of the packets indicating a report time and a consumption amount of the receiving end;
sending report periodically to the transmitting end; and
the transmitting end computing data stream consumption rate using the equation of (Bₙ-B₁)/(Tₙ-T₁), where B and T are buffer consumption amount and report time of the n-th report packets, respectively.

8. The method as claimed in claim 7, wherein the transmitting end adjusts data transporting rate or informs the receiving end to adjust data consumption rate to synchronize the data transporting rate and the data consumption rate.

9. A method of delayed response for real-time network transportation of audio and video data, comprising a step of delaying response sent from a receiving end to a transmitting end to reduce the probability of packet collision.

10. The method as claimed in claim 9, wherein the amount of delay time in the delaying step is randomly determined.

11. The method as claimed in claim 9, wherein the amount of delay time in the delaying step is determined by the system setting.

12. A method of last-in-first-connect policy for real-time network transportation of audio and video data, comprising a step of a second transmitting end interrupting an existing connection between a first transmitting end and a receiving end and establishing a new connection between the second transmitting end and the receiving end.

13. The method as claimed in claim 12, wherein the interrupting step further comprising the steps of:
the second transmitting end receiving a discover response packet from the receiving end; and
the second transmitting end sending requests to the receiving end and the first transmitting end to interrupt the connection and establishing new connection with the receiving end.

14. A method of periodical broadcast of discovering response for real-time network transportation of audio and video data, comprising a step of a receiving end periodically broadcasting response to all transmitting ends on the network to inform the transmitting ends of the existence of the receiving end.
